(19) United States
(12) Patent Application Publication
(10) Pub. No.: US 2017/0078392 A1
(43) Pub. Date: Mar. 16, 2017

(54) Federation and Inter-Organization Collaboration in Data Analysis

(71) Applicant: Skytree, Inc., San Jose, CA (US)

(72) Inventors: Alexander Gray, Santa Clara, CA (US); Sanjay Mehta, Fremont, CA (US)

(21) Appl. No.: 15/266,248

(22) Filed: Sep. 15, 2016

Related U.S. Application Data
(60) Provisional application No. 62/219,068, filed on Sep. 15, 2015.

(51) Int. Cl. H04L 29/08; H04L 29/06

(52) U.S. Cl. CPC H04L 67/1097; H04L 65/4007; H04L 67/02; H04L 67/14

(57) ABSTRACT

A system and method for facilitating collaboration in data analysis workflow across a federation of organizations and their respective computational resources includes determining a workflow, generating a directed acyclic graph (DAG) view of the workflow, receiving, from a first collaborator at a first device, a selection of a portion of the workflow in the DAG view, the selection granting access permission for the portion to a second collaborator, receiving, from the second collaborator at a second device, a request to access the portion, replicating the portion on to the second device based on a trust associated with the workflow, determining whether a data analysis on the portion at the second device is complete, synchronizing a result of the data analysis with rest of the workflow based on the trust associated with the workflow, and updating the DAG view based on synchronizing the result of the data analysis with the rest of the workflow.

### CROSS REFERENCE TO RELATED APPLICATIONS

The present application claims priority, under 35 U.S.C. §119, of U.S. Provisional Patent Application No. 62/219,068, filed Sep. 15, 2015 and entitled “Systems and Methods for Federation and Inter-Organization Collaboration,” which is incorporated by reference in its entirety.

### BACKGROUND

Collaborative systems are implemented in a variety of applications where multiple users engage in a shared activity. Typically, a collaborative system is hosted as a single centralized installation where computational resources and infrastructure for the collaboration on the shared activity are consolidated. The collaborative agents that are collaborating on the shared activity are usually users of the collaborative system. For example, the collaborative system may issue permission to the collaborative agents in the form of web access and authorize an identity of the collaborative agents to access the computational resources storing data and participate in the collaboration on the shared activity. In other words, the collaborative system in the prior art approach tries to consolidate the computational work at one single centralized installation.

Assuming the shared activity that the collaborative agents may engage in is a computationally intensive operation such as, machine learning, then, the prior art collaborative system faces a number of problems and shortcomings. First, the prior art collaborative system can easily become burdened by having to bear the full brunt of the computational load involved ill thine learning because a large amount information is required to be manipulated in Big Data analytical work. In such a scenario, the prior art collaborative system can inevitably end in failures of one or more workloads due to insufficient computational resources. Second, the prior art collaborative system may not let the collaborative agents collaborating on the analytical work dictate how the collaboration may happen by way of restricting access to data models to certain other collaborative agents. In addition, although multi-user machine learning platforms may exist, there is an absence of a machine learning platform that implements collaboration across separate but affiliated organizations, departments or agencies.

Thus, there is a need for a system and method that addresses the long-standing problem of how separate but affiliated organizations can collaborate in analytical work, while also maintaining appropriate boundaries in access to data and models.

### SUMMARY

The present disclosure overcomes the deficiencies of the prior art by providing a system and method for facilitating collaboration in data analysis workflow across a federation of organizations and their respective computational resources.

In general, another innovative aspect of the present disclosure described in this disclosure may be embodied in a method for determining a data analysis workflow, generating a directed acyclic graph view of the data analysis workflow, receiving, from a first collaborator at a first device, a selection of a first portion of the data analysis workflow in the directed acyclic graph view, the first collaborator originating the data analysis workflow and granting access permission for the first portion of the data analysis workflow to a second collaborator, receiving, from the second collaborator at a second device, a request to access the first portion of the data analysis workflow, replicating the first portion of the data analysis workflow on to the second device based on a trust associated with the data analysis workflow, determining whether a first data analysis on the first portion of the data analysis workflow at the second device is complete, responsive to determining that the first data analysis on the first portion of the data analysis workflow at the second device is complete, synchronizing a first result of the first data analysis with rest of the data analysis workflow based on the trust associated with the data analysis workflow, and updating the directed acyclic graph view of the data analysis workflow based on synchronizing the first result of the first data analysis with the rest of the data analysis workflow.

Other aspects include corresponding methods, systems, apparatus, and computer program products for these and other innovative aspects. These and other implementations may each optionally include one or more of the following features.

For instance, the operations further include determining a registry service for facilitating collaboration in the data analysis workflow, the registry service having the first portion of the data analysis workflow as being registered by the first collaborator and discoverable by a third collaborator via the registry service, receiving, from the third collaborator, a request to collaborate with the second collaborator in the data analysis workflow, creating a team including the second collaborator and the third collaborator, determining whether a second data analysis by the team on the first portion of the data analysis workflow is complete, and responsive to determining that the second data analysis by the team on the first portion of the data analysis workflow is complete, transmitting a second result of the second data analysis to a fourth collaborator for review, the fourth collaborator overviewing the data analysis workflow. For instance, the operations further include creating a federation including the first collaborator, the second collaborator, the third collaborator, and the fourth collaborator as collaborative connections in the data analysis workflow, and transmitting, for display, a notification of the updated data analysis workflow to the federation. For instance, the operations further include generating a scoreboard for the first result and the second result, and transmitting, for display, the scoreboard to the federation.

For instance, the features further include the trust associated with the data analysis workflow being based on one or more properties of immutability, non-repudiation, and tamper-resistance associated with the data analysis workflow. For instance, the features further include a topology of the federation including one from a group of a centralized federation and a peer-to-peer federation. For instance, the features further include each of the centralized federation and the peer-to-peer federation being one from a group of a private federation, a semi-private federation, and a public federation. For instance, the features further include a level of the federation including one or more of a federation between a plurality of organizations, a federation between a plurality of departments within an organization, a federation between a plurality of teams within a department in the organization, a federation between a plurality of consortiums, and a federation between a plurality of individuals. For instance, the features further include the first result of the first data analysis including one or more from a group of datasets, models, results, plots, and reports.

The features and advantages described herein are not all-inclusive and many additional features and advantages should be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE DRAWINGS

The disclosure is illustrated by way of example, and not by way of limitation in the figures of the accompanying drawings in which like reference numerals are used to refer to similar elements.

FIG. 1 is a block diagram illustrating an example of a system for facilitating collaboration in analytical work across a federation of organizations in accordance with one implementation of the present disclosure.

FIG. 2 is a block diagram illustrating an example of a collaborative entity in accordance with one implementation of the present disclosure.

FIGS. 3A and 3B are graphical representations illustrating an example user interface for displaying a visual representation of the data analysis workflow in the form of a DAG to a first collaborator, in accordance with one implementation of the present disclosure.

FIG. 3C is a graphical representation that illustrates another example user interface for displaying a visual representation of the data analysis workflow in the form of a DAG to a second collaborator, in accordance with one implementation of the present disclosure.

FIGS. 3D and 3E are graphical representations illustrating an example user interface for synchronizing an update to a portion of the data analysis workflow, in accordance with one implementation of the present disclosure.

FIG. 4 is a graphical representation of an example registry service for facilitating collaboration, in accordance with one implementation of the present disclosure.

FIG. 5 is a graphical representation illustrating an example user interface for displaying an example local scoreboard for data analysis workflow result associated with one or more members of a team, in accordance with one implementation of the present disclosure.

FIG. 6 is a graphical representation illustrating an example user interface for displaying an example global scoreboard for data analysis result associated with a plurality of teams, in accordance with one implementation of the present disclosure.

FIG. 7 is a flowchart of an example method for facilitating collaboration between two or more collaborators in data analysis workflow in accordance with one implementation of the present disclosure.

### DETAILED DESCRIPTION

A system and method for facilitating collaboration in analytical work among a plurality of participating organizations is described. In the following description, for purposes of explanation, numerous specific details are set forth in order to provide a thorough understanding of the disclosure. It should be apparent, however, that the disclosure may be practiced without these specific details. In other instances, structures and devices are shown in block diagram form in order to avoid obscuring the disclosure. For example, the present disclosure is described in one implementation below with reference to particular hardware and software implementations. However, the present disclosure applies to other types of implementations distributed in the cloud, over multiple machines, using multiple processors or cores, using virtual machines or integrated as a single machine.

Reference in the specification to “one implementation” or “an implementation” means that a particular feature, structure, or characteristic described in connection with the implementation is included in at least one implementation of the disclosure. The appearances of the phrase “in one implementation” in various places in the specification are not necessarily all referring to the same implementation. In particular the present disclosure is described below in the context of multiple distinct architectures and some of the components are operable in multiple architectures while others are not.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers or memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a non-transitory computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Aspects of the method and system described herein, such as the logic, may also be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, and so on.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems should appear from the description below. In addition, the present disclosure is described without reference to any particular programming language. It should be appreciated that a variety of programming languages may be used to implement the teachings of the disclosure as described herein.

### Example System(s)

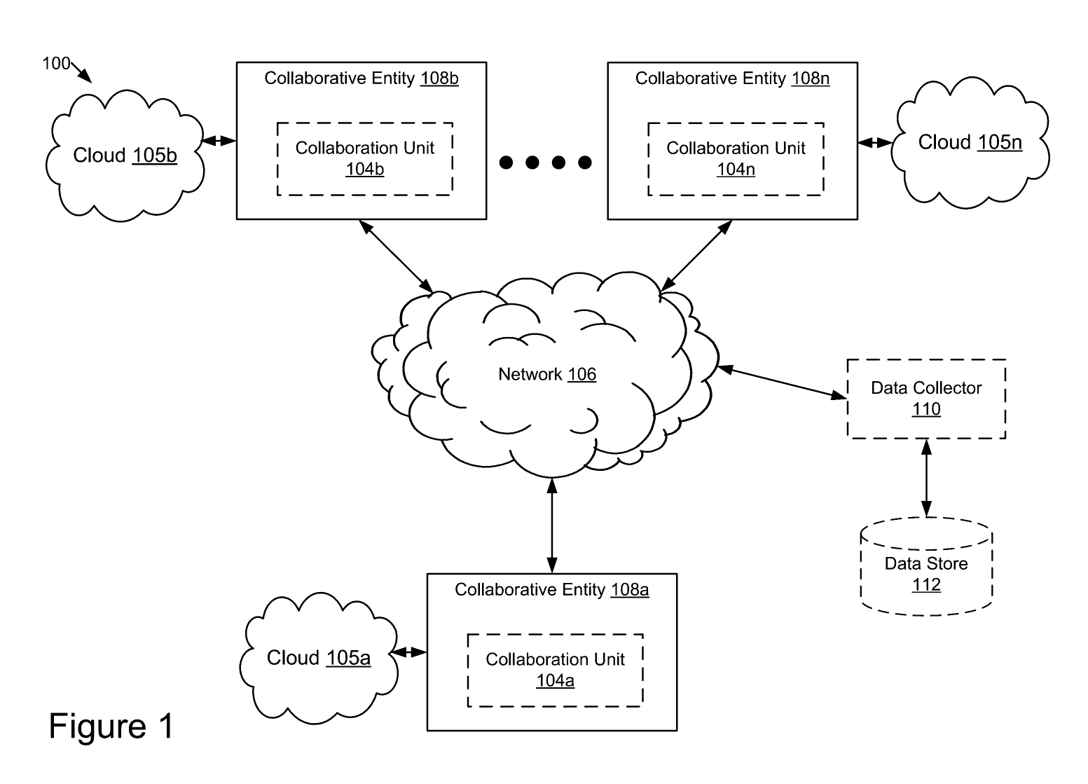

FIG. 1 is a block diagram illustrating an example of a system 100 for facilitating collaboration in analytical work across a federation of organizations in accordance with one implementation of the present disclosure. Referring to FIG. 1, the illustrated system 100 comprises: a plurality of collaborative entities 108a . . . 108n and associated cloud 105a . . . 105n, and, optionally, a data collector 110 and associated data store 112. In FIG. 1 and the remaining figures, a letter after a reference number, e.g., “108a,” represents a reference to the element having that particular reference number. A reference number in the text without a following letter, e.g., “108,” represents a general reference to instances of the element bearing that reference number. In the depicted implementation, the plurality of collaborative entities 108a . . . 108n, and the data collector 110 are communicatively coupled via the network 106.

In some implementations, the collaborative entities 108a . . . 108n represent separate but affiliated organizations collaborating in analytical work, for example, a data analysis workflow, and may be coupled to the network 106 for communication with the other components of the system 100 such as, the data collector 110 and associated data store 112. An organization or a collaborator associated with a collaborative entity 108 may be a single individual, a small group of individuals, a team within a department, a department, or an entire company or enterprise. For example, the collaboration among the collaborative entities 108a . . . 108n may represent inter-agency collaboration, inter-departmental collaboration within an agency, inter-team collaboration within a department, collaboration between an agency and a company or multiple companies, or collaboration between different individuals (i.e. the ‘organizations’ can consist of single individuals). In the collaboration, the participating collaborative entities 108a . . . 108n may be responsible for different parts of the analysis, for example each may work on different datasets which contribute to a larger holistic analysis, or one collaborative entity 108 may work on, say, the data preparation steps of the ultimate data workflow while another may work on the machine learning modeling steps of the workflow. In some implementations, each of the collaborative entities 108a . . . 108n support one or more “native” users and “guest” users. Each of the collaborative entities 108a . . . 108n tracks “native” users distinct from the “guest” users from an access control management perspective.

In some implementations, the collaborative entity 108 grants each “native” and “guest” user specific roles, permissions and capabilities so that they can view, modify, delete, copy or mirror select data science workflow elements in a data analysis workflow, for example, specific projects, datasets, models, results, workflows, plots or reports explicitly or via subproject definitions that include specific datasets, models, results, workflows, plots or reports from a project. The default configuration of a collaborative machine learning system installation implemented by the collaborative entity 108 is for independent and isolated use from any other machine learning system installation within the same organization represented by the collaborative entity 108 or any other machine learning system installation at another organization represented by another collaborative entity 108. For purposes of this application, the terms “project,” “workflow,” “project workflow,” and “data analysis workflow,” are used interchangeably to mean the same thing, namely, a series of transformations and related data science and machine learning tasks that interconnect datasets, models, reports, results, plots, etc. in data science analysis.

Although only three collaborative entities 108a, 108b, and 108n are shown in FIG. 1, it should be understood that there may be any number of collaborative entities 108, which may be in any number and/or in many levels of collaboration with other collaborative entities 108. For example, the collaborative entity 108a may be in a first collaboration with collaborative entity 108b, the collaborative entity 108b may be in a second collaboration with collaborative entity 108n, the collaborative entity 108a may be in a third collaboration with collaborative entity 108n, the collaborative entity 108a and the collaborative entity 108b may form a team (e.g., a local collaboration) and be in a fourth collaboration with the collaborative entity 108n, and so on.

In some implementations, the collaborative entities 108a . . . 108n may be in one or more federations of collaboration with other collaborative entities 108a . . . 108n based on one or more collaboration topologies.

The collaborative entities 108a . . . 108n may be in a collaboration based on a centralized topology that is private within one organization. For example, the collaborative entities 108a . . . 108n may represent individual departments in an organization that are collaborating privately on analytical work and the collaboration is centralized within the organization. The collaborative entities 108a . . . 108n may be in a collaboration based on a centralized topology that is semi-private across selected organizations. For example, the collaborative entities 108a . . . 108n may partner up with select other collaborative entities 108a . . . 108n to collaborate on an analytical workflow. The collaborative entities 108 . . . 108n may be in a collaboration based on a centralized topology that is public and open to any participating organization. For example, each of the collaborative entities 108a . . . 108n may be individual statisticians or data miners who are participants in an analytics competition where one of the collaborative entities 108 is a competition host.

The collaborative entities 108a . . . 108n may be in a collaboration based on a peer-to-peer topology that is private. For example, each of the collaborative entities 108a . . . 108n may be individual but affiliated organizations (e.g., credit card companies) that are collaborating on interpreting a public dataset to deliver to a regulatory body interpretability on the public dataset. In another example, each of the collaborative entities 108a . . . 108n may be individual organizations that jointly bid for a request for proposal (RFP), win the joint bid together, and set up a federation to work collaboratively amongst themselves on the project. The collaborative entities 108a . . . 108n may be in a collaboration based on a peer-to-peer topology that is semi-private. For example, the collaborative entities 108a . . . 108n may post their analytical workflow on one or more private registries and selectively collaborate with other collaborative entities 108a . . . 108n that have also registered themselves on the private registries. The collaborative entities 108a . . . 108n may be in a collaboration based on a peer-to-peer topology that is public. For example, the collaborative entities 108a . . . 108n may post their analytical workflow on one or more public registries and openly collaborate with other collaborative entities 108a . . . 108n that have also registered themselves on the public registries.

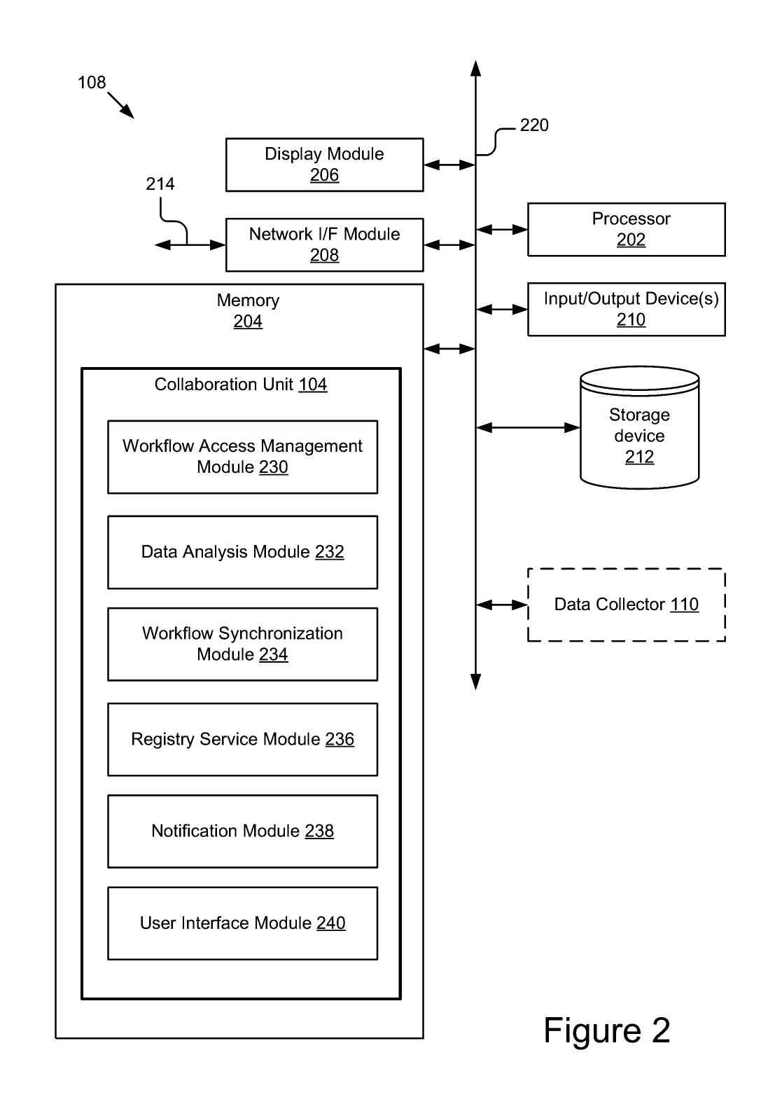

In some implementations, a collaborative entity 108 that takes part in the collaboration has its own computational resources. For example, the collaborative entities 108a . . . 108n may have associated clouds 105a . . . 105n. In the example of FIG. 1, each component of the collaborative entity 108 may be configured to implement the collaboration unit 104 described in detail below with reference to FIG. 2. In some implementations, the collaborative entity 108 provides analytical services to a data analysis customer or collaborator by receiving and processing information from the plurality of resources or devices 108, and 110, for example, to apply transformations on a dataset, create predictive models and, in some instances, score predictions based on those models and generate reports, visualizations, and such. In some implementations, the collaborative entity 108 may be an “on-premises” computing device or a cluster where the data analysis customer has installed the data analysis service for analyzing data and/or for collaboration in analysis, and to which only users designated by the collaborative entity 108 may have permission-based access. For example, data analysis customers, such as a private individual or a team of users in an enterprise may have permission-based access to participate in collaboration of the analytical work.

In some implementations, the collaborative entity 108 may be set up by a data analysis service provider as a Software as a Service (SaaS) platform for the data analysis customer to use in the collaboration with other collaborative entities 108. For example, the data analysis customers interact with the collaborative entity 108 set up as a SaaS platform via an application or web browser on a client device (not shown). The collaborative entity 108 may provide (e.g., in response to a request, individually or for a group of users) the analysis data or workflow. In some implementations, the collaborative entity 108 may be associated with a respective cloud 105 where a variety of individual data analytical workflow performed by the collaborative entity 108 is stored, aggregated or manipulated via shared computer processing resources (e.g., computer networks, servers, storage, applications, and services) on demand. In some implementations, the cloud 105 may be a private cloud (i.e., internal or enterprise cloud) where the analytical data is protected behind a firewall. In other implementations, the cloud 105 may be a public cloud hosted by a third-party data center (not shown) where the analytical data of the collaborative entity 108 is separate from other data hosted in the public cloud by the third-party data center. In some implementations, the collaborative entity 108 may be enclosed within the cloud 105 as part of one or more enterprise services provided by the cloud 105. In some implementations, data analysis customers such as, an individual, a team, or enterprise may request on-demand provisioning of the collaborative entity 108 in the cloud 105. For example, although the collaborative entity 108 is named herein as so, it may be a system unto itself that was originated and set up without any prior indication that it would be used for collaboration in data analysis. The data analysis customer may just begin to initiate and use the collaborative entity 108 in an ad hoc manner for collaboration by requesting an on-demand provisioning in the cloud 105 for the collaboration in analytical work. It may also be understood that private organizations may have the same need for these kinds of inter-organization collaboration that government agencies might do.

In some implementation, the collaborative entities 108a . . . 108n may be client devices or support the client devices that include one or more computing devices having data processing and communication capabilities. In some implementations, a collaborative entity 108 may include a processor (e.g., virtual, physical, etc.), a memory, a power source, a communication unit, and/or other software and/or hardware components, such as a display, graphics processor (for handling general graphics and multimedia processing for any type of application), wireless transceivers, keyboard, camera, sensors, firmware, operating systems, drivers, various physical connection interfaces (e.g., USB, HDMI, etc.). The collaborative entity 108a may couple to and communicate with other collaborative entities 108n and the other entities of the system 100 via the network 106 using a wireless and/or wired connection. The collaborative entity 108a may include a browser application through which the collaborative entity 108a interacts with the other collaborative entities 108n, an application installed enabling the collaborative entity 108a to couple and interact with other collaborative entity 108n, may include a text terminal or terminal emulator application to interact with other collaborative entity 108n, or may couple with other collaborative entity 108n in some other way. Examples of collaborative entities 108a . . . 108n as client devices may include, but are not limited to, mobile phones, tablets, laptops, desktops, netbooks, server appliances, servers, virtual machines, TVs, set-top boxes, media streaming devices, portable media players, navigation devices, personal digital assistants, etc. In addition, the collaborative entities 108a . . . 108n may be the same or different types of computing devices.

In some implementations, for the collaborative entities 108a . . . 108n, there may be one or more overarching computational resources, e.g. a meta-cloud, that can include projects, consisting of associated datasets, workflows, and models, and sub-projects which may contain only subsets of the datasets/workflows/models. The meta-cloud may be a reference to an aggregate of the union of all the information across a federation of the collaborative entities 108a . . . 108n that are participating in a collaboration on analytical work. For example, the collaborative entities 108a . . . 108n are associated with different clouds 105a . . . 105n. The collaborative entities 108a . . . 108n initiate several collaborations by sharing portions of data analysis workflow for collaboration that creates a variety of different federation topologies across the collaborative entities 108a . . . 108n. The meta-cloud may be a representation of a virtual workspace across the federation of the collaborative entities 108a . . . 108n participating in the collaboration.

In some implementations, the collaborative entities 108a . . . 108n with designated access to a project in the meta-cloud can conveniently download and upload datasets/workflows/models to the project on the meta-cloud. The collaborative entities 108a . . . 108n may have a view of the virtual overarching project, including the overall workflow to which they are all simultaneously contributing, and a virtual overarching scoreboard which fuses into one view the relative quality of all of the models produced by various collaborators for the project so that there is a running accounting of the current best models. In this way, actual computational work is performed by each collaborative entity 108 on its own computers, which allows for some necessary segregation of data and models, while allowing joint access and contribution to a virtual overarching project workflow and set of best models.

The data collector 110 is a server or service which collects data and/or analysis from other servers coupled to the network 106. In some implementations, the data collector 110 may be a first or third-party server (that is, a server associated with a separate company or service provider), which mines data, crawls the Internet, and/or obtains data from other servers. For example, the data collector 110 may collect textual data, provide it to other computing devices, such as the collaborative entities 108a . . . 108n and/or perform analysis on it as a service. In some implementations, the data collector 110 may be a data warehouse or belong to a data repository owned by an organization. In some implementations, the data collector 110 may receive data, via the network 106, from one or more of the collaborative entities 108a . . . 108n. In some implementations, the data collector 110 may receive data from real-time or streaming data sources. It should be noted that the data collector 110 and associated data store 112 are shown in FIG. 1 with dashed lines to indicate that they are optional. In some implementations, the data collector 110 and associated data store 112 may be part of each of the collaborative entities 108a . . . 108n and associated cloud 105a . . . 105n. For example, when one or more of the collaborative entities 108a . . . 108n replicate shared data and/or workflow for collaboration among each other, the one or more collaborative entities 108a . . . 108n copy the shared data and/or workflow using their own data collector 110 over the network 106 and store locally in their own data store 112.

The data store 112 is coupled to the data collector 110 and comprises a non-volatile memory device or similar permanent storage device and media. The data collector 110 stores the data in the data store 112 and, in some implementations, provides access to the collaborative entity 108 to obtain the data collected by the data store 112 (e.g. training data, response variables, tuning data, test data, user data, experiments and their results, learned parameter settings, system logs, etc.).

Although only a single data collector 110 and associated data store 112 is shown in FIG. 1, it should be understood that there may be any number of data collectors 110 and associated data stores 112. It should also be recognized that a single data collector 110 may be associated with multiple homogenous or heterogeneous data stores (not shown) in some implementations. For example, the data store 112 may include a relational database for structured data and a file system (e.g. HDFS, NFS, etc.) for unstructured or semi-structured data. It should also be recognized that the data store 112, in some implementations, may include one or more servers hosting storage devices (not shown).

In some implementations, the components 108, 105, and 110 may each be a hardware server, a software server, or a combination of software and hardware. In some implementations, the components 105, 108, and 110 may each be one or more computing devices having data processing (e.g., at least one processor), storing (e.g., a pool of shared or unshared memory), and communication capabilities. For example, the components 105, 108, and 110 may include one or more hardware servers, server arrays, storage devices and/or systems, etc. Also, instead of or in addition, the components 105, 108, and 110 may each implement their own API for the transmission of instructions, data, results, and other information between the components 105, 108, and 110 and an application installed or otherwise implemented on the 105, 108, and 110. In some implementations, the components 105, 108, and 110 may include one or more virtual servers, which operate in a host server environment and access the physical hardware of the host server including, for example, a processor, memory, storage, network interfaces, etc., via an abstraction layer (e.g., a virtual machine manager). In some implementations, one or more of the components 102, 108, and 110 may include a web server (not shown) for processing content requests, such as a Hypertext Transfer Protocol (HTTP) server, a Representational State Transfer (REST) service, or other server type, having structure and/or functionality for satisfying content requests and receiving content from one or more computing devices that are coupled to the network 106.

The network 106 is a conventional type, wired or wireless, and may have any number of different configurations such as a star configuration, token ring configuration or other configurations known to those skilled in the art. Furthermore, the network 106 may comprise a local area network (LAN), a wide area network (WAN) (e.g., the Internet), and/or any other interconnected data path across which multiple devices may communicate. In yet another implementation, the network 106 may be a peer-to-peer network. The network 106 may also be coupled to or include portions of a telecommunications network for sending data in a variety of different communication protocols. In some instances, the network 106 includes Bluetooth communication networks or a cellular communications network for sending and receiving data including via short messaging service (SMS), multimedia messaging service (MMS), hypertext transfer protocol (HTTP), direct data connection, wireless application protocol (WAP), electronic mail, etc.

It should be understood that the present disclosure is intended to cover the many different implementations of the system 100 that include the network 106, the collaborative entities 108a . . . 108n and associated cloud 105a . . . 105n, and the data collector 110 and associated data store 112. In a first example, the collaborative entity 108, and the data collector 110 may each be dedicated devices or machines coupled for communication with each other by the network 106. In a second example, any one or more of the components 108, and 110 may each be dedicated devices or machines coupled for communication with each other by the network 106 or may be combined as one or more devices configured for communication with each other via the network 106. For example, the collaborative entity server 108 and the data collector 110 may be included in the same server. In a third example, any one or more of the components 108, and 110 may be operable on a cluster of computing cores in the cloud 105 and configured for communication with each other. In a fourth example, any one or more of one or more components 108, and 110 may be virtual machines operating on computing resources distributed over the internet.

While the collaborative entities 108a . . . 108n are shown as separate devices in FIG. 1, it should be understood that, in some implementations, the collaborative entities 108a . . . 108n may be integrated into the same device or machine. Moreover, it should be understood that some or all of the elements of the system 100 may be distributed and operate on a cluster or in the cloud using the same or different processors or cores, or multiple cores allocated for use on a dynamic as-needed basis.

### Example Recommendation Server 102

Referring now to FIG. 2, an example of a collaborative entity 108 is described in more detail according to one implementation. The illustrated collaborative entity 108 comprises a processor 202, a memory 204, a display module 206, a network I/F module 208, an input/output device 210, a storage device 212, and, optionally, a data collector 110, coupled for communication with each other via a bus 220. The collaborative entity 108 depicted in FIG. 2 is provided by way of example and it should be understood that it may take other forms and include additional or fewer components without departing from the scope of the present disclosure. For instance, various components of the computing devices may be coupled for communication using a variety of communication protocols and/or technologies including, for instance, communication buses, software communication mechanisms, computer networks, etc. While not shown, the collaborative entity 108 may include various operating systems, sensors, additional processors, and other physical configurations. In some implementations, the data collector 110 in the collaborative entity 108 may be similar in function and form to that described above with reference to FIG. 1, and so like reference number and terminology is used to indicate similar functionality.

The processor 202 comprises an arithmetic logic unit, a microprocessor, a general purpose controller, a field programmable gate array (FPGA), an application specific integrated circuit (ASIC), or some other processor array, or some combination thereof to execute software instructions by performing various input, logical, and/or mathematical operations to provide the features and functionality described herein. The processor 202 processes data signals and may comprise various computing architectures including a complex instruction set computer (CISC) architecture, a reduced instruction set computer (RISC) architecture, or an architecture implementing a combination of instruction sets. The processor(s) 202 may be physical and/or virtual, and may include a single core or plurality of processing units and/or cores. Although only a single processor is shown in FIG. 2, multiple processors may be included. It should be understood that other processors, operating systems, sensors, displays and physical configurations are possible. The processor 202 may also include an operating system executable by the processor 202 such as but not limited to WINDOWS®, Mac OS®, or UNIX® based operating systems. In some implementations, the processor(s) 202 may be coupled to the memory 204 via the bus 220 to access data and instructions therefrom and store data therein. The bus 220 may couple the processor 202 to the other components of the collaborative entity 108 including, for example, the display module 206, the network I/F module 208, the input/output device(s) 210, and the storage device 212.

The memory 204 may store and provide access to data to the other components of the collaborative entity 108. The memory 204 may be included in a single computing device or a plurality of computing devices. In some implementations, the memory 204 may store instructions and/or data that may be executed by the processor 202. For example, as depicted in FIG. 2, the memory 204 may store the collaboration unit 104, and its respective components, depending on the configuration. The memory 204 is also capable of storing other instructions and data, including, for example, an operating system, hardware drivers, other software applications, databases, etc. The memory 204 may be coupled to the bus 220 for communication with the processor 202 and the other components of collaborative entity 108.

The instructions stored by the memory 204 and/or data may comprise code for performing any and/or all of the techniques described herein. The memory 204 may be a dynamic random access memory (DRAM) device, a static random access memory (SRAM) device, flash memory or some other memory device known in the art. In some implementations, the memory 204 also includes a non-volatile memory such as a hard disk drive or flash drive for storing information on a more permanent basis. The memory 204 is coupled by the bus 220 for communication with the other components of the collaborative entity 108. It should be understood that the memory 204 may be a single device or may include multiple types of devices and configurations.

The display module 206 may include software and routines for sending processed data, analytics, or reports for display to a collaborator, for example, to allow an administrator or collaborator to interact with the collaborative entity 108. In some implementations, the display module 206 may include hardware, such as a graphics processor, for rendering interfaces, data, analytics, or recommendations.

The network I/F module 208 may be coupled to the network 106 (e.g., via signal line 214) and the bus 220. The network I/F module 208 links the processor 202 to the network 106 and other processing systems. In some implementations, the network I/F module 208 also provides other conventional connections to the network 106 for distribution of files using standard network protocols such as transmission control protocol and the Internet protocol (TCP/IP), hypertext transfer protocol (HTTP), hypertext transfer protocol secure (HTTPS) and simple mail transfer protocol (SMTP) as should be understood to those skilled in the art. In some implementations, the network I/F module 208 is coupled to the network 106 by a wireless connection and the network I/F module 208 includes a transceiver for sending and receiving data. In such an alternate implementation, the network I/F module 208 includes a Wi-Fi transceiver for wireless communication with an access point. In another alternate implementation, the network I/F module 208 includes a Bluetooth® transceiver for wireless communication with other devices. In yet another implementation, the network I/F module 208 includes a cellular communications transceiver for sending and receiving data over a cellular communications network such as via short messaging service (SMS), multimedia messaging service (MMS), hypertext transfer protocol (HTTP), direct data connection, wireless application protocol (WAP), email, etc. In still another implementation, the network I/F module 208 includes ports for wired connectivity such as but not limited to USB, SD, or CAT-5, CAT-5e, CAT-6, fiber optic, etc.

The input/output device(s) (“I/O devices”) 210 may include any device for inputting or outputting information from the collaborative entity 108 and may be coupled to the system either directly or through intervening I/O controllers. An input device may be any device or mechanism of providing or modifying instructions in the collaborative entity 108. For example, the input device may include one or more of a keyboard, a mouse, a scanner, a joystick, a touchscreen, a webcam, a touchpad, a touchscreen, a stylus, a barcode reader, an eye gaze tracker, a sip-and-puff device, a voice-to-text interface, etc. An output device may be any device or mechanism of outputting information from the recommendation server 102. For example, the output device may include a display device, which may include light emitting diodes (LEDs). The display device represents any device equipped to display electronic images and data as described herein. The display device may be, for example, a cathode ray tube (CRT), liquid crystal display (LCD), projector, or any other similarly equipped display device, screen, or monitor. In one implementation, the display device is equipped with a touch screen in which a touch sensitive, transparent panel is aligned with the screen of the display device. The output device indicates the status of the recommendation server 102 such as: 1) whether it has power and is operational; 2) whether it has network connectivity; 3) whether it is processing transactions. Those skilled in the art should recognize that there may be a variety of additional status indicators beyond those listed above that may be part of the output device. The output device may include speakers in some implementations.

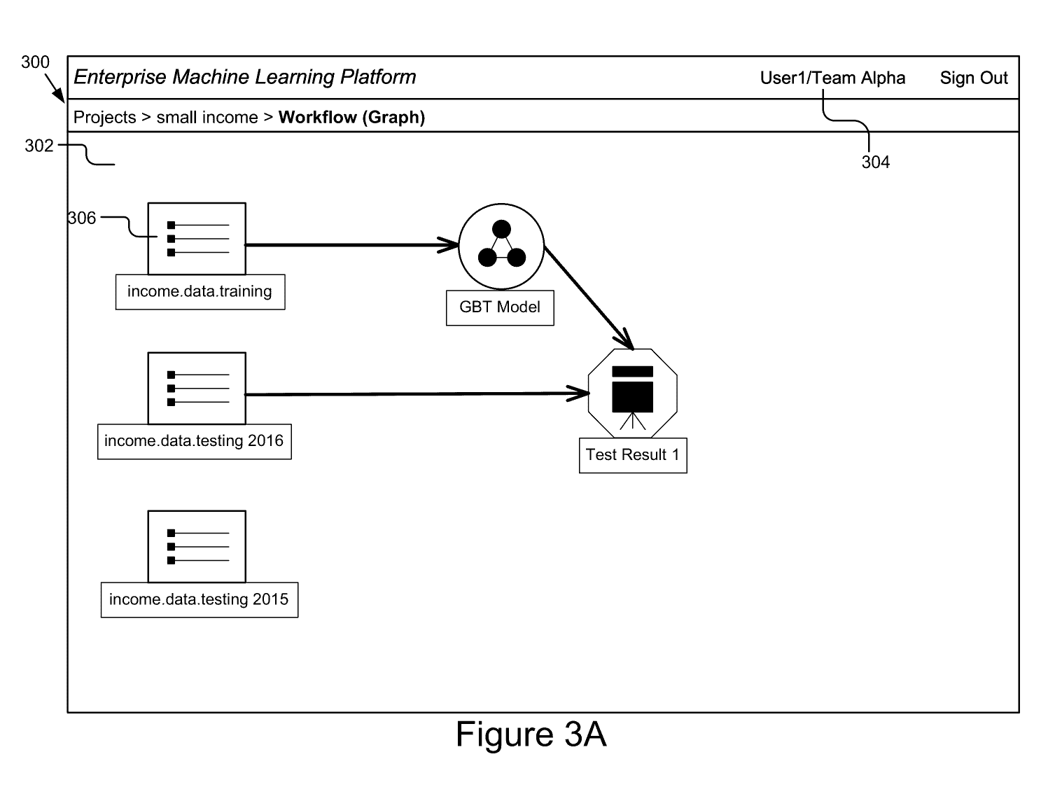

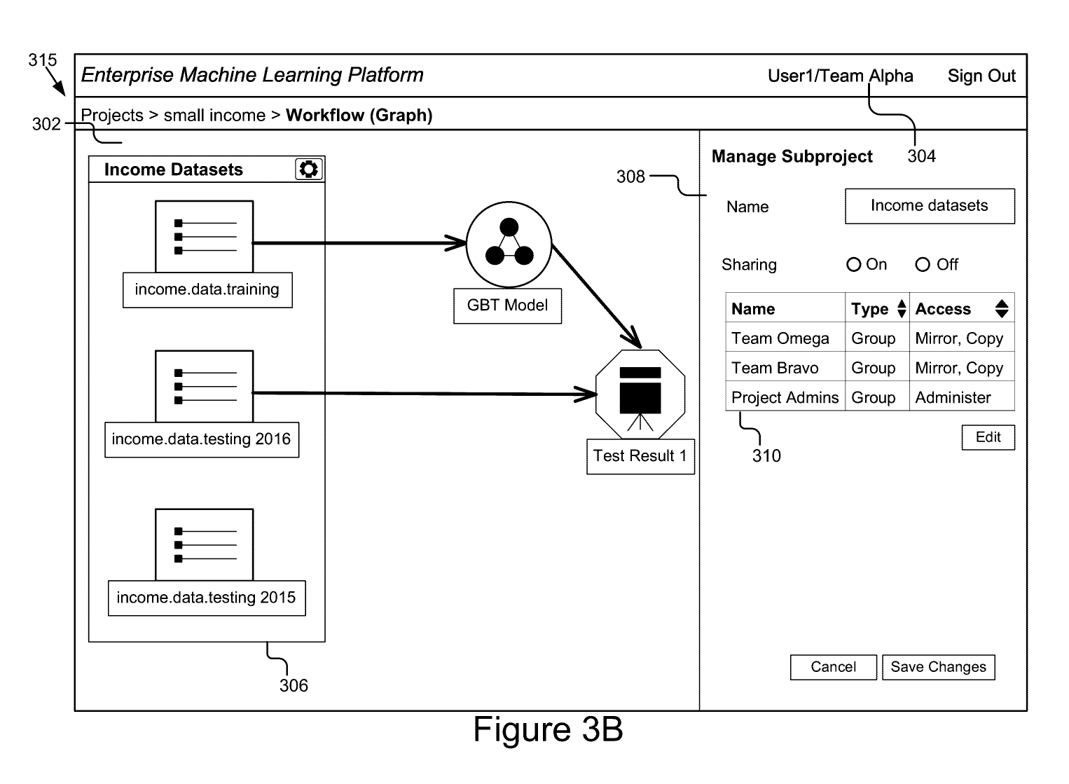

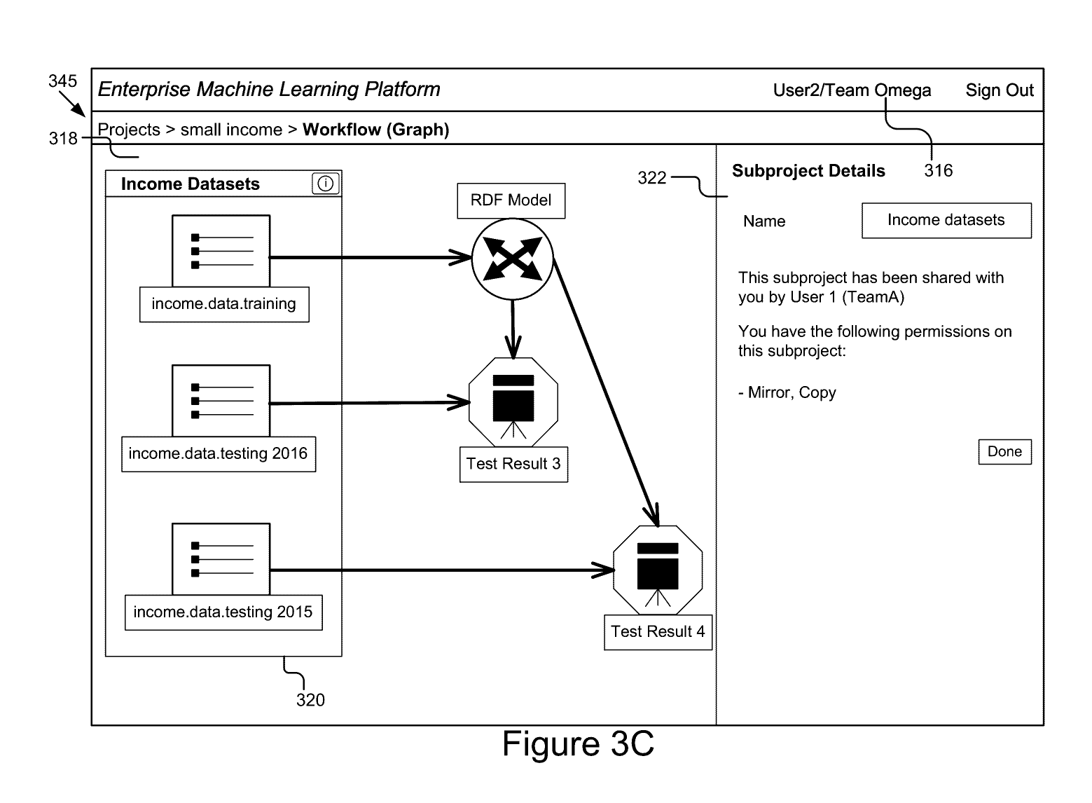

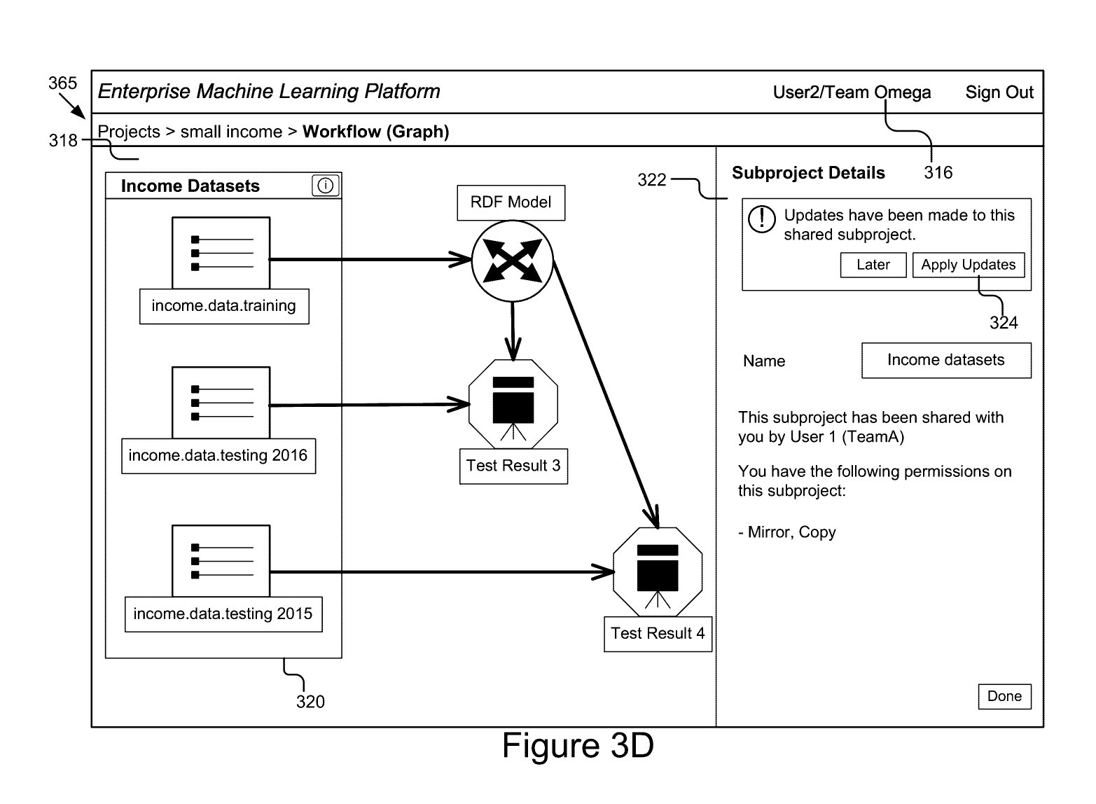

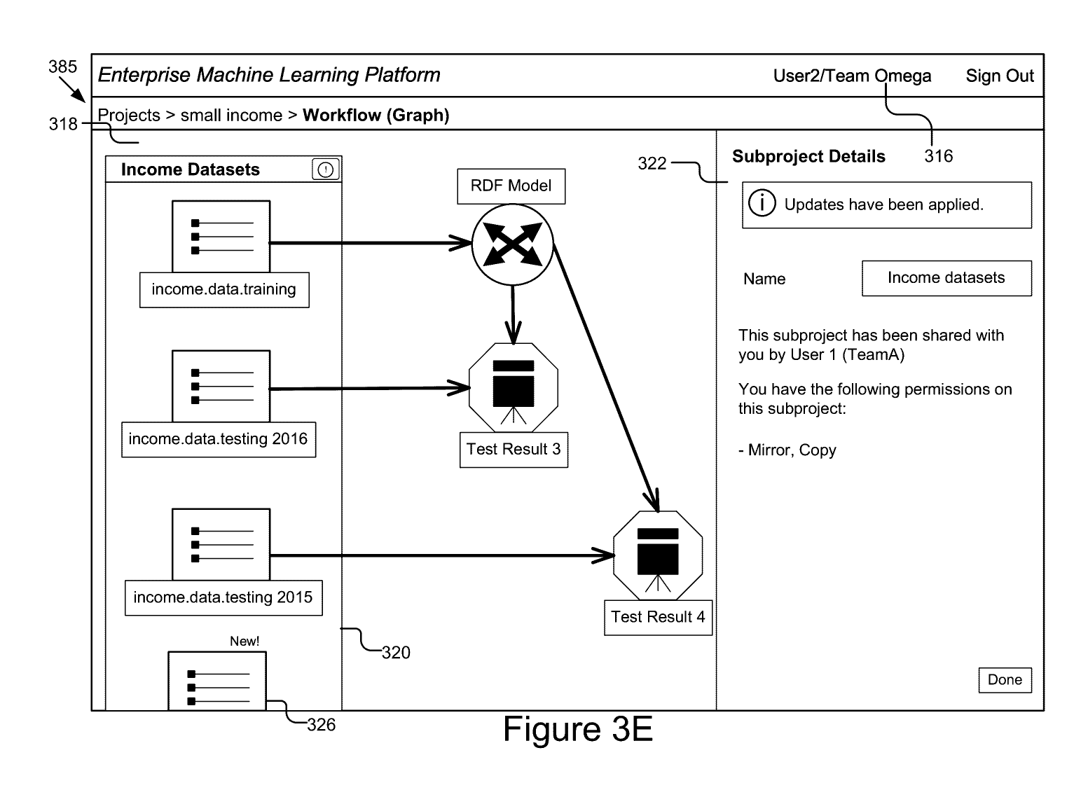

The storage device 212 is an information source for storing and providing access to data, such as the data described in reference to FIGS. 3-7 and including a plurality of datasets, model(s), constraints, etc. The data stored by the storage device 212 may be organized and queried using various criteria including any type of data stored therein. The storage device 212 may include data tables, databases, or other organized collections of data. The storage device 212 may be included in the collaborative entity 108 or in another computing system and/or storage system distinct from but coupled to or accessible by the collaborative entity 108. The storage device 212 may include one or more non-transitory computer-readable mediums for storing data. In some implementations, the storage device 212 may be incorporated with the memory 204 or may be distinct therefrom. In some implementations, the storage device 212 may store data associated with a relational database management system (RDBMS) operable on the recommendation server 102. For example, the RDBMS could include a structured query language (SQL) RDBMS, a NoSQL RDMBS, various combinations thereof, etc. In some instances, the RDBMS may store data in multi-dimensional tables comprised of rows and columns, and manipulate, e.g., insert, query, update and/or delete, rows of data using programmatic operations. In some implementations, the storage device 212 may store data associated with a Hadoop distributed file system (HDFS) or a cloud based storage system such as Amazon™ S3. In some implementations, the storage device 212, in addition, may be associated with the data collector 110 and include similar functionality of the data store 112 described above with reference to FIG. 1.

The bus 220 represents a shared bus for communicating information and data throughout the collaborative entity 108. The bus 220 may represent one or more buses including an industry standard architecture (ISA) bus, a peripheral component interconnect (PCI) bus, a universal serial bus (USB), or some other bus known in the art to provide similar functionality which is transferring data between components of a computing device or between computing devices, a network bus system including the network 106 or portions thereof, a processor mesh, a combination thereof, etc. In some implementations, the processor 202, memory 204, display module 206, network I/F module 208, input/output device(s) 210, storage device 212, various other components operating on the collaborative entity 108 (operating systems, device drivers, etc.), and any of the components of the collaboration unit 104 may cooperate and communicate via a communication mechanism included in or implemented in association with the bus 220. The software communication mechanism may include and/or facilitate, for example, inter-process communication, local function or procedure calls, remote procedure calls, an object broker (e.g., CORBA), direct socket communication (e.g., TCP/IP sockets) among software modules, UDP broadcasts and receipts, HTTP connections, etc. Further, any or all of the communication could be secure (e.g., SSH, HTTPS, etc.).

As depicted in FIG. 2, the collaboration unit 104 may include and may signal the following to perform their functions: a workflow access management module 230 that provides selective access to portions of a data analysis workflow for collaboration, a data analysis workflow 232 that performs analysis on the selected portions of the data analysis workflow, a workflow synchronization module 234 that synchronizes a result of the data analysis performed on the portion of the data analysis workflow with rest of the data analysis workflow, a registry service module 236 that registers one or more data analysis workflows in a registry for facilitating collaboration, a notification module 238 that generates notifications or periodic updates for the data analysis workflow, and a user interface module 240 that generates a user interface for displaying a directed acyclic graph (DAG) view of the data analysis workflow, a registry for collaboration among the collaborative entities 108a . . . 108n, and a scoreboard that keeps a running account of, for example, current best models generated by collaborators. These components 230, 232, 234, 236, 238, 240 and/or components thereof, may be communicatively coupled by the bus 220 and/or the processor 202 to one another and/or the other components 206, 208, 210, and 212 of the collaborative entity 108. In some implementations, the components 230, 232, 234, 236, 238, and/or 240 may include computer logic (e.g., software logic, hardware logic, etc.) executable by the processor 202 to provide their acts and/or functionality. In any of the foregoing implementations, these components 230, 232, 234, 236, 238, and/or 240 may be adapted for cooperation and communication with the processor 202 and the other components of the collaborative entity 108.

It should be recognized that the collaboration unit 104 and disclosure herein applies to and may work with Big Data, which may have billions or trillions of elements (rows×columns) or even more, and that the disclosure is adapted to scale to deal with such large datasets, resulting large models and results, while maintaining intuitiveness and responsiveness to interactions.

The workflow access management module 230 includes computer logic executable by the processor 202 to process a data analysis workflow and provide selective access, capabilities, and permissions to one or more portions of the data analysis workflow. In some implementations, the workflow access management module 230 determines a data analysis workflow and sends instructions to the user interface module 240 to generate a visual representation of the data analysis workflow in the form of a directed acyclic graph (DAG). The DAG view may track the execution history (i.e., date, time, etc.) of various actions performed or taken by one or more collaborators in the data analysis workflow. For example, the DAG view may simplify the audit trail of the data analysis workflow and transformation sequence through the data analysis workflow at different points.

The workflow access management module 230 determines that the data analysis workflow is associated with an example first collaborator such as, a project owner, a native user, or administrator at the first collaborative entity 108. Native users or administrators of each collaborative entity 108 can share specific projects or sub-projects with all guest users or specific guest users. In some implementations, the workflow access management module 230 receives a selection of a portion of the data analysis workflow from the first collaborator. For example, the first collaborator may select the portion on the DAG view of the data analysis workflow for sharing with an example second collaborator (e.g. guest user). The workflow access management module 230 receives access permission from the first collaborator for the portion of the data analysis workflow. For example, the first collaborator associated with a first collaborative entity 108 creates access permission that provides selective access and capabilities to the second collaborator associated with a second collaborative entity 108 at the same organization (e.g., another native user) or a different organization (e.g., guest user).

FIGS. 3A and 3B are graphical representations illustrating an example user interface for displaying a visual representation of the data analysis workflow in the form of a DAG to a first collaborator. In graphical representation 300 of FIG. 3A, the user interface is generated for the first collaborator “User 1/Team Alpha” 304 who may be a project owner associated with the DAG 302. The DAG 302 labels each node 306 in a visually distinct manner to allow the first collaborator 304 to determine the sequence transformation in the DAG 302. In the graphical representation 315 of FIG. 3B, the first collaborator 304 creates a subproject “Income Datasets” 306 for sharing with a second collaborator 316 discussed in FIG. 3C. The first collaborator 304 graphically selects the nodes in the DAG 302 to selectively share a portion of the DAG 302 with the second collaborator 316. Responsive to the first collaborator 304 graphically selecting the portion of the DAG 302, the graphical representation 315 of FIG. 3B includes a side panel 308 where the first collaborator 304 can manage the subproject details. For example, the portion of the DAG 302 selected by the first collaborator 304 is named as “Income Datasets” 306. The “Income Datasets” 306 is highlighted in the DAG 302 shown in the graphical representation 315. The side panel 308 includes a table 310 in which the first collaborator 304 sets access permission for one or more other collaborators.

In some implementations, the workflow access management module 230 receives a request from the second collaborator seeking to self-register and receive approval at the first collaborative entity 108 for accessing the portion of the data analysis workflow. The workflow access management module 230 processes the request and creates access permission for the portion of the data analysis workflow based on an approval provided by the first collaborator associated with the first collaborative entity 108. In some implementations, the workflow access management module 230 receives a list of pre-approved collaborators wanting to access the portion of the data analysis workflow at the first collaborative entity 108, and creates user accounts for the list of pre-approved collaborators. The workflow access management module 230 sends instructions to the notification module 238 to notify the list of pre-approved collaborators via push notifications about the created user accounts to use at the first collaborative entity 108 to secure access to the portion of the data analysis workflow. These pre-approved collaborators who may be native or guest users will gain automatic visibility upon login at the first collaborative entity 108 as well as via push notifications to shared projects and sub-projects that is accessible to them based on access permission.

In some implementations, the workflow access management module 230 receives a request from the first collaborator to create a project specific workgroup at the first collaborative entity 108. The first collaborator who may be a project owner can invite other native users or even guest users to be part of this workgroup. For example, the first collaborator may allow collaboration on the project amongst a number of collaborators that may be across departments of the same organization, or collaborators across different organizations. While adding native and/or guest users to the project specific workgroup, the workflow access management module 230 receives specific access control and permission to one or more workflow elements or objects with the project. In some implementations, at the first collaborative entity 208, the workflow access management module 230 tracks native users distinctly from guest users from an access control management perspective. For example, each native user and guest user may be granted specific roles, permissions and capabilities within each collaborative entity 108 so that they can view, modify, delete, copy or mirror specific projects, datasets, models, results, workflows, plots or reports explicitly or via sub-project definitions that include specific datasets, models, results, workflows, plots or reports from a project.

In some implementations, the workflow access management module 230 authorizes the access permission of the second collaborator (e.g., native and/or guest users) to the portion of the data analysis workflow at the first collaborative entity 108. The workflow access management module 230 creates a federation that includes the first collaborator and the second collaborator as collaborative connections in the data analysis workflow. The workflow access management module 230 replicates the portion of the data analysis workflow from the first collaborative entity 108 (where the second collaborator is a guest user) on to the second collaborative entity 108 (where the second collaborator is a native user). For example, the workflow access management module 230 executes a copy operation that results in a physical copy of the requested items of the data analysis workflow replicated from the first collaborative entity 108 on to the second collaborative entity 108. In some implementations, the workflow access management module 230 usefully maintains one or more portions of the data analysis workflow in the meta-cloud of the participating collaborative entities 108a . . . 108n and the replication of the one or more portions of the data analysis workflow may happen to and/or from the meta-cloud. It can be understood that the copy operation is not one way, there can be a copy operation from the second collaborative entity 108 to the first collaborative entity depending on the participating collaborators and their associated access permissions to portions of data analysis workflow.

FIG. 3C is a graphical representation 345 that illustrates another example user interface for displaying a visual representation of the data analysis workflow in the form of a DAG to a second collaborator. In this graphical representation 345 of FIG. 3C, the user interface is generated for the second collaborator “User 2/Team Omega” 316. The user interface includes the DAG 318 for the second collaborator 316 and a side panel 322 that indicates what subproject is shared with the second collaborator 316 and what type of access permission the second collaborator 316 has been granted with regard to the subproject. For example, the first collaborator 304 has given the second collaborator 316 permission to mirror and copy the subproject “Income Datasets” 306 from FIG. 3B. When the second collaborator 316 copies or replicates the subproject “Income Datasets” 306 from FIG. 3B, the DAG 318 includes a replicated portion 320 of data analysis workflow that was selectively shared by the first collaborator 304 with the second collaborator 316. As can be seen in FIG. 3C, the second collaborator 316 may perform a distinct data analysis on the replicated portion 320 as part of the collaboration to generate models and reports.

In some implementations, the workflow access management module 230 approves an example third collaborator associated with a third collaborative entity 108 and having appropriate access permission to the portion of the data analysis workflow to form a local group collaboration with the second collaborator on the portion of data analysis workflow. For example, the workflow access management module 230 receives a request from the third collaborator to collaborate with the second collaborator. The second collaborator and the third collaborator act as a team and collaborate on the portion of the data analysis workflow with the first collaborator. In some implementations, the workflow access management module 230 approves an example fourth collaborator associated with a fourth collaborative entity 108 and having appropriate access permission to the data analysis workflow to oversee the collaboration and/or result of the collaboration at various junctures of the data analysis workflow in progress. For example, the fourth collaborator may be a competition host overseeing an analytics competition where the first collaborator, the second collaborator, and the third collaborator are producing their own models based on the portion of the data analysis workflow. It should be understood that the mention of the first, the second, the third, and the fourth collaborator is for purposes of clarity and description, and is not intended to be limiting. It is equally possible and contemplated in the techniques described herein that there can be other collaborators forming many groups and sub-groups for sharing a data analysis workflow for collaboration.

The data analysis module 232 includes computer logic executable by the processor 202 to perform data analysis on the portion of the data analysis workflow at a collaborative entity 108 where the portion of the data analysis workflow is replicated by the workflow access management module 230 for collaboration. For example, the data analysis module 232 analyzes the portion of the data analysis workflow replicated on the second collaborative entity 108 (where the second collaborator is a native user) by the workflow access management module 230. In some implementations, the data analysis module 232 performs data preparation steps on the portion of the data analysis workflow including a dataset to prepare the data for training a model. For example, the data analysis module 232 may execute machine learning specific transformations such as, Normalization, Horizontalization, Moving Window Statistics, Text Transformations, etc. In another example, the data analytics module 232 may perform functional transformations such as, addition transformation, subtraction transformation, multiplication transformation, division transformation, greater than transformation, lesser than transformation, equals transformations, contains transformations, etc. for appropriate types of data columns found in the dataset in the data analysis workflow. In another example, the data preparation transformation applied to the data analysis workflow can be a custom transformation developed by a collaborator at the collaborative entity 108 where the portion of the data analysis workflow is replicated.

In some implementations, the data analysis module 232 performs machine learning modeling steps on the portion of the data analysis workflow including data prepared for training a model. The data analysis module 232 may use any number of machine learning techniques to generate a model. The data analysis module 232 automatically and simultaneously selects between distinct machine learning methods and finds optimal model parameters for building the model for various machine learning tasks. The data analysis module 232 can alternatively allow the user to interactively or programmatically select machine learning method and specific model parameters for building specific models. Example of machine learning tasks include, but are not limited to, classification, regression, and ranking. The data analysis module 232 measures the performance of the trained model and optimizes the performance using one or more measures of fitness. Examples of potential fitness include, but are not limited to, error rate, F-score, area under curve (AUC), Gini, precision, performance stability, time cost, etc. In some implementations, the data analysis module 232 generates reports, visualizations, and plots on items including models, datasets, results, etc. in the portion of the data analysis workflow. For example, the data analysis module 232 generates visualizations such as, partial dependence plot visualizations, heat map visualizations, bar chart visualizations, etc. In another example, the data analysis module 232 uses the visualizations, the interaction of items (e.g., models, datasets, features, etc.) in the data analysis workflow, the audit trail of the data analysis workflow or any other available information to generate a report. The data analysis module 232 may generate the report in any number of formats including MS-PowerPoint, portable document format, HTML, XML, etc.

The workflow synchronization module 234 includes computer logic executable by the processor 202 to synchronize a result of the data analysis performed by the data analysis module 232 on the portion of the data analysis workflow with rest of the data analysis workflow. In some implementations, the workflow synchronization module 234 determines whether a contribution of a data analysis performed on a replicated portion of the data analysis workflow is complete. For example, the workflow synchronization module 234 determines whether analysis on the portion of the data analysis workflow replicated from the first collaborative entity 108 (where the second collaborator is a guest user) to the second collaborative entity 108 (where the second collaborator is a native user) is complete at the second collaborative entity 108. The workflow synchronization module 234 executes a mirror operation that results in a setup of automatic synchronization of changes beyond the initial copy of the portion of the data analysis workflow. This automatic synchronization updates the overall data analysis workflow accordingly.

In some implementations, the workflow synchronization module 234 accesses the meta-cloud of the participating collaborative entities 108a . . . 108n to mirror the changes and/or updates to the replicated portion of the data analysis workflow with rest of the data analysis workflow. For example, the workflow synchronization module 234 receives a contribution from the second collaborator as a result of data preparation steps performed on the portion of the data analysis workflow at the second collaborative entity 108 and updates the data analysis workflow. In some implementations, the workflow synchronization module 234 sends instructions to the notification module 238 to notify other collaborators participating in the data analysis workflow to the changes and/or updates made to the overall data analysis workflow as a result of the collaboration among the collaborators. For example, the third collaborator collaborating with the second collaborator as a team gets a notification of the update to the data analysis workflow. In another example, the fourth collaborator overseeing the data analysis workflow gets a notification of the update to the data analysis workflow. In some implementations, the workflow synchronization module 234 receives a confirmation from other collaborators in response to a notification and updates the overall analysis workflow accordingly.

FIGS. 3D and 3E are graphical representations illustrating an example user interface for synchronizing an update to a portion of the data analysis workflow. In graphical representation 365 of FIG. 3D, the user interface includes the DAG 318 for the second collaborator 316 and the side panel 322 that indicates an availability of update to the shared project 320. In graphical representation 385 of FIG. 3E, the user interface is refreshed to show an updated shared project 320 that now includes a new income dataset 326 in response to the second collaborator 316 selecting the “Apply Updates” button 324 in FIG. 3D.

In some implementations, the DAG of the data analysis workflow is an unmodifiable and trustworthy audit trail of data science activity performed by one or more collaborators. The replication and synchronization of the data analysis workflow as performed by the workflow access management module 230 and the workflow synchronization module 234 is trusted across the federation of collaborative entities 108a . . . 108n participating in the collaboration, where trusted refers to the qualities of immutability, non-repudiation and non-tamperability (i.e., tamper resistance) associated with the replication and synchronization of data and workflow across the dynamically formed federations. When portions of the DAG including datasets, models, results and other data science workflow elements are selectively shared or partially shared across a federation, the shared elements can be similarly trusted across the federation because the replication and synchronization will maintain the non-repudiation and non-tamperability of the overall DAG across the meta-cloud of the collaborative entities 108a . . . 108n. Analytics competitions can trust the models and results posted by participants in the competition if these are from other collaborative entities 108a . . . 108n within the federation. Since models and results can be considered as nodes of the DAG, they carry the immutability, non-repudiation and non-tamperability qualities wherever they are replicated. The process of cloning and/or synchronizing projects or sub-projects is advantageous in that it allows collaborators to utilize their local computing resources to work or analyze data on their part of the project and then upload a result of their analysis, for example, produced datasets, models, results and so on to a target collaborative entity or a meta-cloud where collaboration connections are pre-established.

A registry service module 236 includes computer logic executable by the processor 202 to register one or more data analysis workflows in a registry service for facilitating collaboration. In some implementations, the registry service module 236 receives a request from a first collaborator to register one or more data analysis workflows associated with the first collaborative entity 108 at one or more registry services. The one or more registry services can be private or public registry services depending on the configuration of how the federation of collaboration is intended. In some implementations, a registry service may be locally hosted within one collaborative entity 108 and the other collaborative entities 108 subscribe to that registry service and register themselves with the registry service. This allows collaborators to not only discover other collaborative entities 108a . . . 108n at the same or different organization in the registry service, but also discover interesting projects or workflows that are made available to guest users by these collaborative entities 108a . . . 108n. The establishment and use of the one or more registry services and the ability to connect to one or more such registry services provides the peer-to-peer capabilities for the federation in collaboration and supports guest users within each of the collaborative entities 108a . . . 108n. For example, the registry service allows non-enterprise, individual collaborators among the collaborative entities 108a . . . 108n to form teams or workgroups. This is useful in an event, such as analytics competition where the analytics competition is posted by a collaborative entity 108 in a registry service. Individual users discover the competition via the registry service to which they have subscribed, the individual users can form teams and collaborate as a team before submitting their models and results for the competition. The individual users and multi-user teams join the federation that includes the collaborative entity 108 that is hosting the competition. In some implementations, the registry service module 236 sends instructions to the user interface module 240 to generate a user interface displaying a registry for facilitating collaboration.

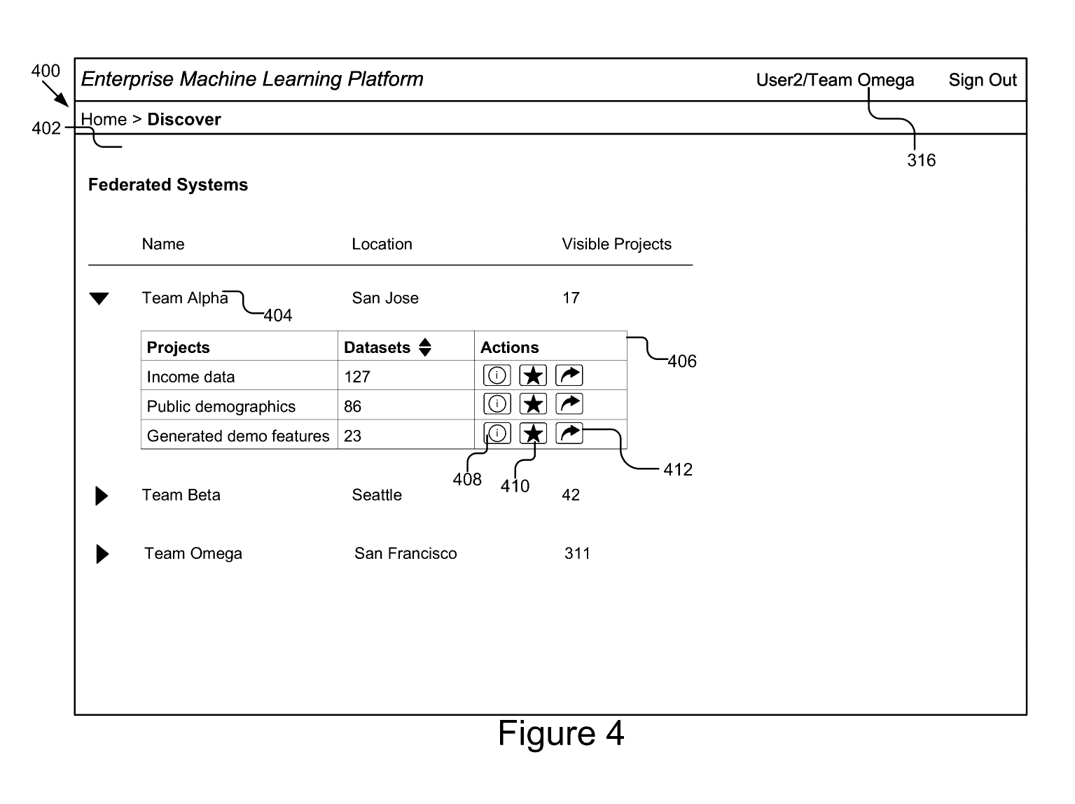

FIG. 4 is a graphical representation 400 that illustrates an example user interface for displaying a registry service for facilitating collaboration. In this graphical representation 400, the user interface includes a registry service 402 subscribed to by the second collaborator 316. The registry service 402 lists other collaborators registered with the registry service 402 and the projects that the other collaborates are sharing. For example, the collaborator “Team Alpha” 404 is sharing a list 406 of projects. The second collaborator 316 can take actions with respect to the shared list 406 of projects. For example, the second collaborator 316 can select the “More Details” icon 408 to get more information on the shared project. In another example, the second collaborator 316 can select the “Favorite” icon 410 to favorite the shared project for future use or easy access. In another example, the second collaborator 316 can select the “Use” icon 412 to immediately make use of the shared project and start the collaboration in the data analysis of that shared project.

The notification module 238 includes computer logic executable by the processor 202 to generate notifications and/or periodic updates for the data analysis workflow. In some implementations, the notification module 238 identifies the established collaborative connections in a federation of collaborative entities 108a . . . 108n collaborating on the same data analysis workflow or portion of the data analysis workflow. The notification module 238 uses the collaborative connections to facilitate the exchange of status and results associated with the one or more portions of the data analysis workflow across the federation of collaborative entities 108a . . . 108n. For example, the notification module 238 sends notifications or periodic updates for data analysis workflow that each native or guest user is involved in so that they stay up-to-date on contributions by others collaborating with them on the projects.

In some implementations, the notification module 238 sends instructions to the user interface module 240 to generate an overall dashboard of local and remotely shared data analysis workflows or portions of the data analysis workflows to specific native and guest users in the federation of collaborative entities 108a . . . 108n. The dashboard is dynamically filtered for the specific native and guest users. The notification module 238 attributes all work done locally or remotely in each project or sub-project to the corresponding native and/or guest user performing the work, regardless of whether the work product (e.g., datasets, models, results, plots, reports) is being seen directly or via the overall dashboard, and regardless of where the work product is being seen, either local (before replication or synchronization) or remote (after replication or synchronization).

In some implementations, the notification module 238 generates special reports for presenting to the collaborators in the data analysis workflow or project. For example, the notification module 238 generates a special report for the project owners and/or project sponsors, such as an analytics competition judge that includes the entire project history consolidated from the collaborative entities 108a . . . 108n through which the collaborators participated in the project. In some implementations, the notification module 238 instructs the user interface module 240 to generate a scoreboard/dashboard for ranking the results of the analysis performed on the workflow by the collaborators. For example, the notification module 238 receives the Gini scores for the models contributed by the collaborators working on a portion of the data analysis workflow and builds a scoreboard based on the Gini scores.

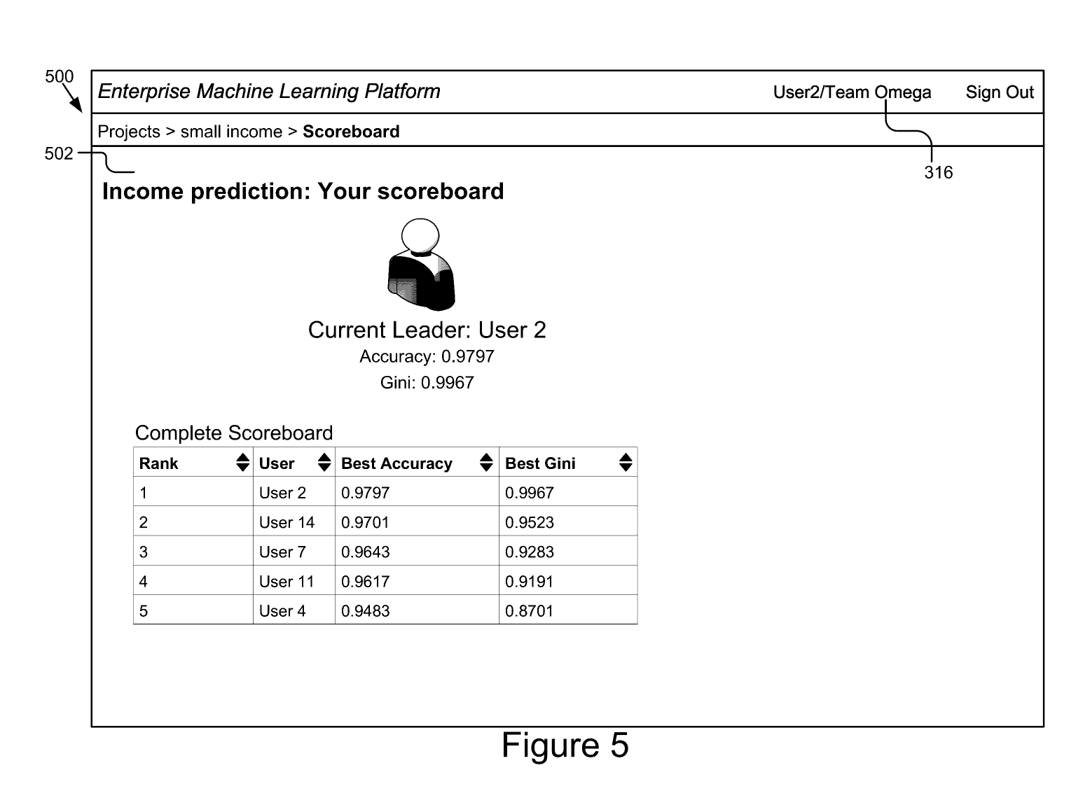

FIG. 5 is a graphical representation 500 illustrating an example user interface for displaying an example local scoreboard 502 for data analysis workflow result associated with one or more members of a team. In this graphical representation 500, the user interface includes a local scoreboard 502 for models built by members of a team locally collaborating with each on a data analysis workflow. The local scoreboard 502 is displaying models associated with “Income Prediction” that are built by the members of the team. The local scoreboard 502 is shared with each of the members of the team. For example, the individual members “User 2,” “User 14,” “User 7,” “User 11,” and “User 4” may have found each other in a registry service and agreed to form a team in an analytics competition for building an “Income Prediction” model. The local scoreboard 502 is indicating that the current leader is “User 2” 316. The local scoreboard 502 is dynamically created and modified by the team members as they form the team and sub-teams.

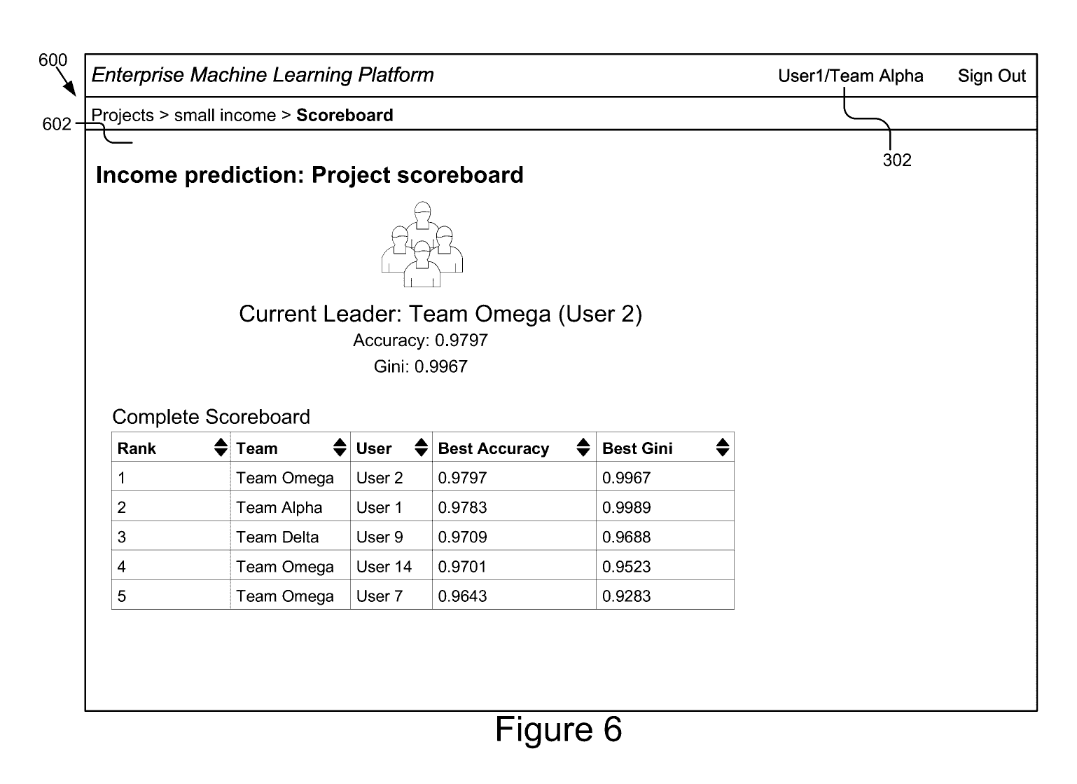

FIG. 6 is a graphical representation 600 illustrating an example user interface for displaying an example global scoreboard 602 for data analysis result associated with a plurality of teams. Each team may be considered as a single collaborator competing with each other in building a model for “Income Prediction.” The global scoreboard 602 lists the individual teams, a particular user from each team that submitted the model, the best accuracy offered by the model, and the best Gini score of the model. In some implementations, there can be a team of just one individual user.

The user interface module 240 includes computer logic to generate user interfaces as illustrated in FIGS. 3-6 for displaying a directed acyclic graph (DAG) view of the data analysis workflow, a registry for collaboration among the collaborative entities 108a . . . 108n, and a scoreboard that keeps a running account of, for example, current best models generated by the one or more collaborators. In some implementations, the user interface module 240 cooperates and coordinates with other components of the collaboration unit 104 by receiving instructions and generating one or more user interfaces that allows the collaborator to selectively share a portion of the data analysis workflow, generate access permission for the portion of the data analysis workflow, generate notifications, and synchronize a change or update to the portion of the data analysis workflow.

It should be understood that the federation of collaboration discussed in reference to and represented in FIGS. 3-6 are provided as an example, is not intended to be limiting, and other types of collaboration in analytical work are possible and contemplated in the techniques described herein.

### Example Methods

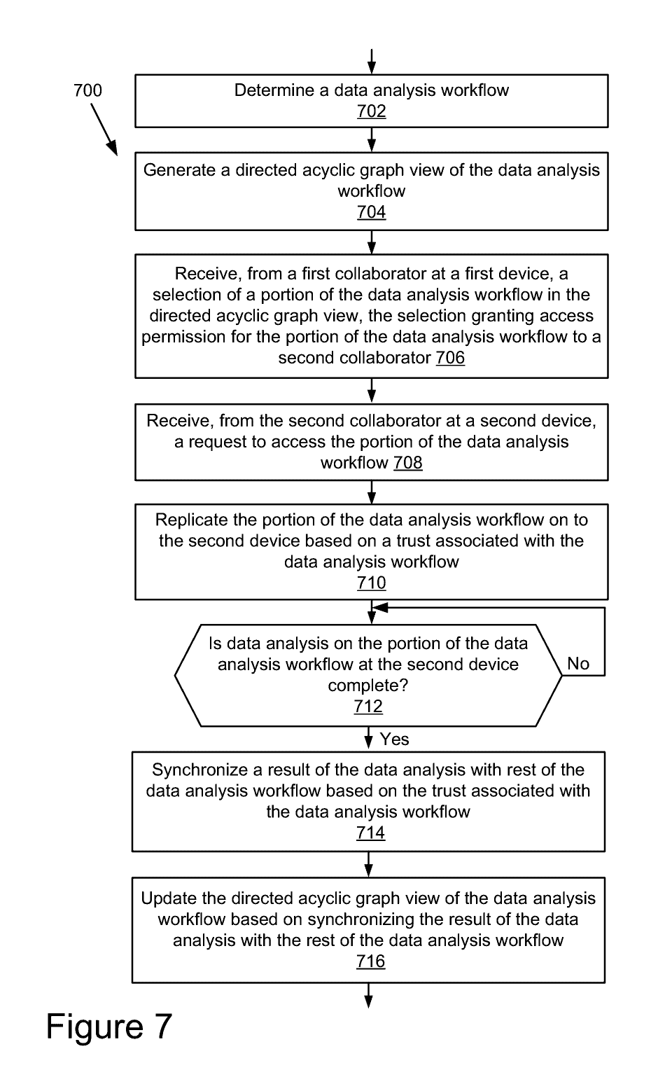

FIG. 7 is a flowchart of an example method 700 for facilitating collaboration between two or more collaborators in data analysis workflow in accordance with one implementation of the present disclosure. At block 702, the workflow access management module 230 determines a data analysis workflow. At 704, the user interface module 240 generates a directed acyclic graph view of the data analysis workflow. At block 706, the workflow access management module 230 receives, from a first collaborator at a first device, a selection of a portion of the data analysis workflow in the directed acyclic graph view, the selection granting access permission for the portion of the data analysis workflow to a second collaborator.

At 708, the workflow access management module 230 receives, from a second collaborator, a request to access the portion of the data analysis workflow. At 710, the workflow access management module 230 replicates the portion of the data analysis workflow on to the second device based on a trust associated with the data analysis workflow. At 712, the workflow synchronization module 234 determines whether data analysis on the portion of the data analysis workflow at the second device is complete. If the data analysis is not complete, the method 700 repeats the process at 712. If the data analysis is complete, at 714, the workflow synchronization module 234 synchronizes a result of the data analysis with rest of the data analysis workflow based on the trust associated with the data analysis workflow. At 716, the user interface module 240 updates the directed acyclic graph view of the data analysis workflow based on synchronizing the result of the data analysis with the rest of the data analysis workflow.

The foregoing description of the implementations of the present disclosure has been presented for the purposes of illustration and description. It is not intended to be exhaustive or to limit the present disclosure to the precise form disclosed. Many modifications and variations are possible in light of the above teaching. It is intended that the scope of the present disclosure be limited not by this detailed description, but rather by the claims of this application. As should be understood by those familiar with the art, the present disclosure may be embodied in other specific forms without departing from the spirit or essential characteristics thereof. Likewise, the particular naming and division of the modules, routines, features, attributes, methodologies and other aspects are not mandatory or significant, and the mechanisms that implement the present disclosure or its features may have different names, divisions and/or formats. Furthermore, as should be apparent to one of ordinary skill in the relevant art, the modules, routines, features, attributes, methodologies and other aspects of the present disclosure may be implemented as software, hardware, firmware or any combination of the three. Also, wherever a component, an example of which is a module, of the present disclosure is implemented as software, the component may be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the present disclosure is in no way limited to implementation in any specific programming language, or for any specific operating system or environment. Accordingly, the disclosure of the present disclosure is intended to be illustrative, but not limiting, of the scope of the present disclosure, which is set forth in the following claims.

What is claimed is:

1. A computer-implemented method comprising:
determining, using one or more computing devices, a data analysis workflow;
generating, using the one or more computing devices, a directed acyclic graph view of the data analysis workflow;
receiving, using the one or more computing devices, from a first collaborator at a first device, a selection of a first portion of the data analysis workflow in the directed acyclic graph view, the first collaborator originating the data analysis workflow and granting access permission for the first portion of the data analysis workflow to a second collaborator;
receiving, using the one or more computing devices, from the second collaborator at a second device, a request to access the first portion of the data analysis workflow;
replicating, using the one or more computing devices, the first portion of the data analysis workflow on to the second device based on a trust associated with the data analysis workflow;
determining, using the one or more computing devices, whether a first data analysis on the first portion of the data analysis workflow at the second device is complete;
responsive to determining that the first data analysis on the first portion of the data analysis workflow at the second device is complete, synchronizing a first result of the first data analysis with rest of the data analysis workflow based on the trust associated with the data analysis workflow; and
updating, using the one or more computing devices, the directed acyclic graph view of the data analysis workflow based on synchronizing the first result of the first data analysis with the rest of the data analysis workflow.

2. The computer-implemented method of claim 1, further comprising:
determining a registry service for facilitating collaboration in the data analysis workflow, the registry service having the first portion of the data analysis workflow as being registered by the first collaborator and discoverable by a third collaborator via the registry service;
receiving, from the third collaborator, a request to collaborate with the second collaborator in the data analysis workflow;
creating a team including the second collaborator and the third collaborator;
determining whether a second data analysis by the team on the first portion of the data analysis workflow is complete; and
responsive to determining that the second data analysis by the team on the first portion of the data analysis workflow is complete, transmitting a second result of the second data analysis to a fourth collaborator for review, the fourth collaborator overviewing the data analysis workflow.

3. The computer-implemented method of claim 2, further comprising:
creating a federation including the first collaborator, the second collaborator, the third collaborator, and the fourth collaborator as collaborative connections in the data analysis workflow; and
transmitting, for display, a notification of the updated data analysis workflow to the federation.

4. The computer-implemented method of claim 3, further comprising:
generating a scoreboard for the first result and the second result; and
transmitting, for display, the scoreboard to the federation.

5. The computer-implemented method of claim 1, wherein the trust associated with the data analysis workflow is based on one or more properties of immutability, non-repudiation, and tamper-resistance associated with the data analysis workflow.

6. The computer-implemented method of claim 3, wherein a topology of the federation includes one from a group of a centralized federation and a peer-to-peer federation.

7. The computer-implemented method of claim 6, wherein each of the centralized federation and the peer-to-peer federation is one from a group of a private federation, a semi-private federation, and a public federation.

8. The computer-implemented method of claim 3, wherein a level of the federation includes one or more of a federation between a plurality of organizations, a federation between a plurality of departments within an organization, a federation between a plurality of teams within a department in the organization, a federation between a plurality of consortiums, and a federation between a plurality of individuals.

9. The computer-implemented method of claim 1, wherein the first result of the first data analysis includes one or more from a group of datasets, models, results, plots, and reports.

10. A system comprising:
one or more processors; and
a memory including instructions that, when executed by the one or more processors, cause the system to:
determine a data analysis workflow;
generate a directed acyclic graph view of the data analysis workflow;
receive, from a first collaborator at a first device, a selection of a first portion of the data analysis workflow in the directed acyclic graph view, the first collaborator originating the data analysis workflow and granting access permission for the first portion of the data analysis workflow to a second collaborator;
receive, from the second collaborator at a second device, a request to access the first portion of the data analysis workflow;
replicate the first portion of the data analysis workflow on to the second device based on a trust associated with the data analysis workflow;
determine whether a first data analysis on the first portion of the data analysis workflow at the second device is complete;
responsive to determining that the first data analysis on the first portion of the data analysis workflow at the second device is complete, synchronize a first result of the first data analysis with rest of the data analysis workflow based on the trust associated with the data analysis workflow; and
update the directed acyclic graph view of the data analysis workflow based on synchronizing the first result of the first data analysis with the rest of the data analysis workflow.

11. The system of claim 10, wherein the instructions, when executed by the one or more processors, further cause the system to:
determine a registry service for facilitating collaboration in the data analysis workflow, the registry service having the first portion of the data analysis workflow as being registered by the first collaborator and discoverable by a third collaborator via the registry service;
receive, from the third collaborator, a request to collaborate with the second collaborator in the data analysis workflow;
create a team including the second collaborator and the third collaborator;
determine whether a second data analysis by the team on the first portion of the data analysis workflow is complete; and
responsive to determining that the second data analysis by the team on the first portion of the data analysis workflow is complete, transmit a second result of the second data analysis to a fourth collaborator for review, the fourth collaborator overviewing the data analysis workflow.

12. The system of claim 11, wherein the instructions, when executed by the one or more processors, further cause the system to:
create a federation including the first collaborator, the second collaborator, the third collaborator, and the fourth collaborator as collaborative connections in the data analysis workflow; and
transmit, for display, a notification of the updated data analysis workflow to the federation.

13. The system of claim 12, wherein the instructions, when executed by the one or more processors, further cause the system to:
generate a scoreboard for the first result and the second result; and
transmit, for display, the scoreboard to the federation.

14. The system of claim 10, wherein the trust associated with the data analysis workflow is based on one or more properties of immutability, non-repudiation, and tamper-resistance associated with the data analysis workflow.

15. The system of claim 12, wherein a level of the federation includes one or more of a federation between a plurality of organizations, a federation between a plurality of departments within an organization, a federation between a plurality of teams within a department in the organization, a federation between a plurality of consortiums, and a federation between a plurality of individuals.

16. A computer-program product comprising a non-transitory computer usable medium including a computer readable program, wherein the computer readable program, when executed on a computer, causes the computer to perform operations comprising:
determining a data analysis workflow;
generating a directed acyclic graph view of the data analysis workflow;
receiving, from a first collaborator at a first device, a selection of a first portion of the data analysis workflow in the directed acyclic graph view, the first collaborator originating the data analysis workflow and granting access permission for the first portion of the data analysis workflow to a second collaborator;
receiving, from the second collaborator at a second device, a request to access the first portion of the data analysis workflow;
replicating the first portion of the data analysis workflow on to the second device based on a trust associated with the data analysis workflow;
determining whether a first data analysis on the first portion of the data analysis workflow at the second device is complete;
responsive to determining that the first data analysis on the first portion of the data analysis workflow at the second device is complete, synchronizing a first result of the first data analysis with rest of the data analysis workflow based on the trust associated with the data analysis workflow; and
updating the directed acyclic graph view of the data analysis workflow based on synchronizing the first result of the first data analysis with the rest of the data analysis workflow.

17. The computer program product of claim 16, wherein the operations further comprise:
determining a registry service for facilitating collaboration in the data analysis workflow, the registry service having the first portion of the data analysis workflow as being registered by the first collaborator and discoverable by a third collaborator via the registry service;
receiving, from the third collaborator, a request to collaborate with the second collaborator in the data analysis workflow;
creating a team including the second collaborator and the third collaborator;
determining whether a second data analysis by the team on the first portion of the data analysis workflow is complete; and
responsive to determining that the second data analysis by the team on the first portion of the data analysis workflow is complete, transmitting a second result of the second data analysis to a fourth collaborator for review, the fourth collaborator overviewing the data analysis workflow.

18. The computer program product of claim 17, wherein the operations further comprise:
creating a federation including the first collaborator, the second collaborator, the third collaborator, and the fourth collaborator as collaborative connections in the data analysis workflow; and
transmitting, for display, a notification of the updated data analysis workflow to the federation.

19. The computer program product of claim 18, wherein the operations further comprise:
generating a scoreboard for the first result and the second result; and
transmitting, for display, the scoreboard to the federation

20. The computer program product of claim 16, wherein the trust associated with the data analysis workflow is based on one or more properties of immutability, non-repudiation, and tamper-resistance associated with the data analysis workflow.
